(19) United States
(12) Patent Application Publication
(10) Pub. No.: US 2004/0116075 A1
(43) Pub. Date: Jun. 17, 2004

(54) Dual platform communication controller, method of controlling a dual platform communication and wireless communication system employing the same

(75) Inventors: Matthew B. Shoemake, Allen, TX (US); Jie Liang, Plano, TX (US); Paul F. Struhsaker, Plano, TX (US); Eli Dekel, Tzur Igal (IL)

Correspondence Address: TEXAS INSTRUMENTS INCORPORATED, P O BOX 655474, M/S 3999, DALLAS, TX, 75265

(73) Assignee: Texas Instruments Incorporated, Dallas, TX

(21) Appl. No.: 10/722,681

(22) Filed: Nov. 25, 2003

Related U.S. Application Data
(60) Provisional application No. 60/434,094, filed on Dec. 17, 2002.

(51) Int. Cl. H04B 7/00

(52) U.S. Cl. 455/41.2; 455/39

(57) ABSTRACT

The present invention is directed to a dual platform communication controller for use with a wireless communication system. In one embodiment, the dual platform communication controller includes a signal interpreter coupled to the wireless communication system and configured to recognize a first signal packet based on a first communication standard and a second signal packet based on a second communication standard. The dual platform communication controller also includes a traffic manager coupled to the signal interpreter and configured to provide a deterministic time-sharing between the first and second signal packets within the wireless communication system.

### CROSS-REFERENCE TO PROVISIONAL APPLICATION

This application claims the benefit of U.S. Provisional Application No. 60/434,094 entitled “Mechanism for Bluetooth and IEEE 802.11 Coexistance” to Matthew B. Shoemake, et al., filed on Dec. 17, 2002, which is incorporated herein by reference in its entirety.

### TECHNICAL FIELD OF THE INVENTION

The present invention is directed, in general, to wireless communication and, more specifically, to a dual platform communication controller, a method of controlling a dual platform communication and a wireless communication system employing the controller and the method.

### BACKGROUND OF THE INVENTION

A steadily increasing demand for wireless networks is being driven by the proliferation of mobile computing devices including laptops, personal digital assistants (PDAs) and other computer-based or communication-based units. These wireless networks allow such devices in proximity to share information and resources. A challenge in the design and successful deployment of these wireless networks involves the real-world need to operate in a hostile radio environment that may include noise, time-varying channels and abundant electromagnetic interference. A key challenge occurs when two different wireless networks, based on differing standards, employ the same frequency band and operate in close or overlapping proximity to one another.

Wireless personal area networks (WPANs) may employ a Bluetooth or an IEEE 802.15 standard in forming a personal wireless network using the 2.4 GHz ISM frequency band. This frequency band may also be employed by Wireless Local Area Networks (WLANs) based on one of the IEEE 802.11 standards, as well. A Bluetooth WPAN typically employs short-range (up to 10 meters), modest performance (721 Kbps), a dynamically configurable operating mode (ad hoc employing peer-to-peer networking and roaming), low power and support for both voice and data. A WLAN typically employs longer range (up to 30 meters), higher performance (up to 11 Mbps), operating modes having either ad hoc or infrastructure structures (an access point coupled to a wired LAN), higher power and support for both voice and data.

WLAN and WPAN devices operating in proximity may also significantly impact the performance and signal quality of both devices. Analysis and statistical techniques have been employed to estimate a probability of signal packet error based on the probability of packet collision in time and frequency. Although these analytical results can give a first order approximation of the impact of interference and performance degradation, they often make assumptions concerning traffic distributions and operation of the media access protocol that are less than realistic. Other techniques attempt to provide a lower probability of collision through coincident frequency avoidance approaches. However, high priority occurrences, such as voice signal packets, offer a particular challenge to analytical and statistical collision avoidance techniques since they are typically not re-transmitable.

Accordingly, what is needed in the art is a more structured way to share a communication space between proximate wireless networks.

### SUMMARY OF THE INVENTION

To address the above-discussed deficiencies of the prior art, the present invention is directed to a dual platform communication controller for use with a wireless communication system. In one embodiment, the dual platform communication controller includes a signal interpreter coupled to the wireless communication system and configured to recognize a first signal packet based on a first communication standard and a second signal packet based on a second communication standard. The dual platform communication controller also includes a traffic manager coupled to the signal interpreter and configured to provide a deterministic time-sharing between the first and second signal packets within the wireless communication system.

In another aspect, the present invention provides a method of controlling a dual platform communication for use with a wireless communication system. The method includes recognizing a first signal packet based on a first communication standard and a second signal packet based on a second communication standard. The method also includes providing a deterministic time-sharing between the first and second signal packets within the wireless communication system.

The present invention also provides, in yet another aspect, a wireless communication system. The wireless communication system includes a first wireless network based on a first communication standard that employs a first wireless station and a first signal packet, and a second wireless network based on a second communication standard that employs a second wireless station and a second signal packet. The wireless communication system also includes a dual platform communication controller coupled to the first and second wireless networks. The dual platform communication controller has a signal interpreter that recognizes the first signal packet based on the first communication standard and the second signal packet based on the second communication standard, and a traffic manager, coupled to the signal interpreter, that provides a deterministic time-sharing between the first and second signal packets within the wireless communication system.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a system diagram of an embodiment of a wireless communication system constructed in accordance with the principles of the present invention;

FIG. 2 illustrates a block diagram of an embodiment of a dual platform communication controller constructed in accordance with the principles of the present invention;

FIG. 3 illustrates a flow diagram of an embodiment of a method of controlling a dual platform communication carried out in accordance with the principles of the present invention; and

FIG. 4 illustrates a flow diagram of an embodiment of a method of controlling a dual platform communication carried out in accordance with the principles of the present invention.

### DETAILED DESCRIPTION

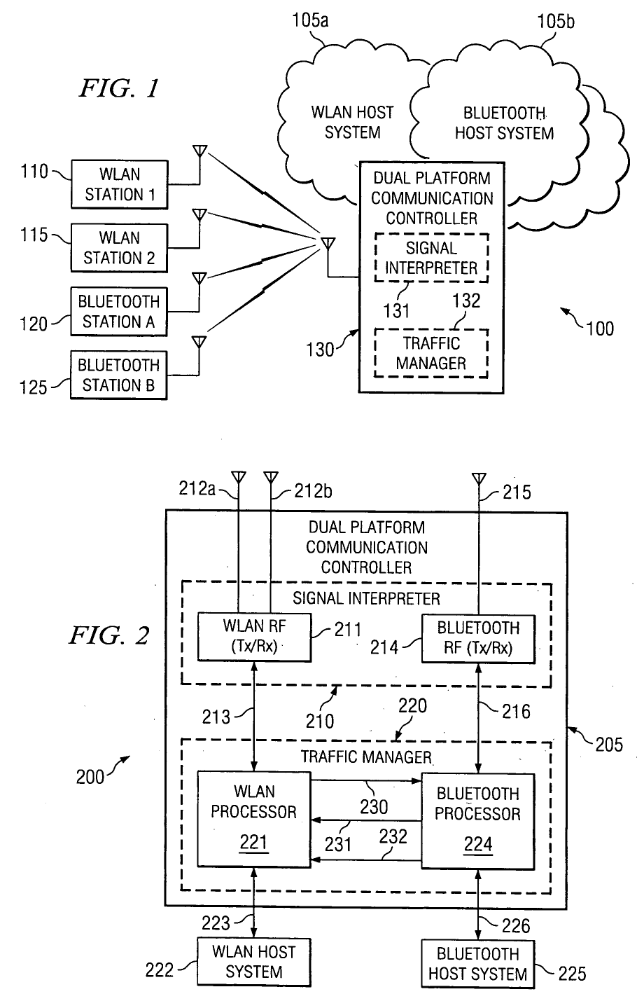

Referring initially to FIG. 1, illustrated is a system diagram of an embodiment of a wireless communication system, generally designated 100, constructed in accordance with the principles of the present invention. The wireless communication system 100 includes a first wireless network based on the IEEE 802.11 communication standard that provides a wireless local area network (WLAN), and a second wireless network based on the Bluetooth communication standard that provides a wireless personal area network (WPAN). The WLAN includes a WLAN host system 105a and first and second WLAN stations 110, 115 that employ WLAN signal packets. The WPAN includes a Bluetooth host system 105b and first and second Bluetooth stations 120, 125 that employ WPAN signal packets. The wireless communication system 100 also includes a dual platform communication controller 130, which forms a part of both the WLAN and the WPAN.

In the illustrated embodiment, the dual platform communication controller 130 includes a signal interpreter 131 that recognizes the WLAN signal packet and the WPAN signal packet. The dual platform communication controller 130 also includes a traffic manager 132, coupled to the signal interpreter 131, that provides a deterministic time-sharing between the WLAN and WPAN signal packets within the wireless communication system 100. The deterministic time-sharing feature afforded by the traffic manager 132 provides a collaborative coexistence medium that substantially avoids collisions between the WLAN and WPAN signal packets. This is typically required since the WLAN and the WPAN employ the same frequency bands and occupy proximate physical spaces, in the illustrated embodiment. Additionally, the traffic manager 132 provides a priority for the WPAN based on a real-time requirement and also provides time-sharing between the WLAN and WPAN signal packets based on a period of time. The traffic manager 132 may inhibit a transmission capability of at least one of the WLAN and WPAN signal packets and operate in a default state having listening and standby modes.

In the illustrated embodiment, the dual platform communication controller 130 operates as a WLAN access point for the first and second WLAN stations 110, 115 and as a WPAN master for the first and second Bluetooth stations 120, 125, which act as WPAN slaves. In alternative embodiments, the dual platform communication controller 130 may also operate as a WLAN station and a WPAN master or as a WLAN station and a WPAN slave. When there is coexistent WLAN and WPAN traffic, the dual platform communication controller 130 allows sharing of the medium to accommodate both types of traffic. This may be accomplished by allowing the WLAN to transmit and receive for a first time period of TWLAN milliseconds and allowing the WPAN to transmit and receive for a second time period of TWPAN milliseconds, once the first time period has expired. Alternation of these first and second time periods continues until only one of the wireless networks has traffic wherein that traffic is accommodated on a full-time basis.

When there is neither WLAN or WPAN traffic, the dual platform communication controller 130 operates in a default state wherein a normal operating mode of the WPAN is allowed full-time. During this time, operation of the WLAN may be is placed in a listen mode or a sleep mode until WLAN traffic occurs. When WLAN traffic does occur, operation of the dual platform communication controller 130 proceeds as discussed above. In all operating modes, the dual platform communication controller 130 does not interrupt a WPAN transmission by removing power from a WPAN transmitter or an associated power amplifier, since this action would cause a spurious transmission to occur.

If a request for a WPAN priority transmission occurs at any time in the previously discussed normal operating modes, the dual platform communication controller 130 shifts to a priority operating mode. The priority operating mode allows a WPAN priority transmission, such as speech, to be accommodated in real-time since it will not be re-transmitted and therefore lost. Once the WPAN priority transmission is complete, the dual platform communication controller 130 returns to its normal operating mode.

Turning now to FIG. 2, illustrated is a block diagram of an embodiment of a dual platform communication controller, generally designated 200, constructed in accordance with the principles of the present invention. The dual platform communication controller 200 may be employed in the wireless communication system 100 as was discussed with respect to FIG. 1 or within another wireless communication system and includes a signal interpreter 210 and a traffic manager 220. The signal interpreter 210 includes a WLAN RF section 211 having an antenna array 212 employing first and second WLAN antennas 212a, 212b and a Bluetooth RF section 214 having a Bluetooth antenna 215. The traffic manager 220 includes a WLAN processor 221 and a Bluetooth processor 224.

The WLAN processor 221 is coupled to the WLAN RF section 211 with a WLAN signal bus 213 and to a WLAN host system 222 with a WLAN host interface bus 223. Similarly, the Bluetooth processor 224 is coupled to the Bluetooth RF section 214 with a Bluetooth signal bus 216 and to a Bluetooth host system 225 with a Bluetooth host interface bus 226. The WLAN processor 221 is coupled to the Bluetooth processor 224 with a Bluetooth transmit enable bus 230. Similarly, the Bluetooth processor 224 is coupled to the WLAN processor 221 with a Bluetooth transmit attempted bus 231 and a Bluetooth transmit priority bus 232. Of course, the dual platform communication controller 200 may employ an implementation of the signal interpreter 210 and the traffic manager 220 that is contained in one or more integrated circuits, as appropriate.

In the illustrated embodiment, the WLAN RF section 211 and the WLAN processor 221 cooperate to process signal information from the WLAN host system 222 and transmit WLAN signal packets employing the antenna array 212 to a WLAN station, which is not shown. The WLAN RF section 211 and the WLAN processor 221 also cooperate to receive signal packets from the WLAN station and process them for presentation to the WLAN host system 222. Similarly, the Bluetooth RF section 214 and the Bluetooth processor 224 cooperate to process signal information from the Bluetooth host system 225 and transmit Bluetooth signal packets employing the Bluetooth antenna 215 to a Bluetooth station, which is not shown. The Bluetooth RF section 214 and the Bluetooth processor 224 also cooperate to receive signal packets from the Bluetooth station and process them for presentation to the Bluetooth host system 225.

In a normal operating mode, the Bluetooth transmit enable bus 230 may be asserted allowing Bluetooth traffic to flow spontaneously when there is no WLAN traffic present. When WLAN traffic occurs, the Bluetooth transmit enable bus 230 is de-asserted after a time period thereby prohibiting further Bluetooth transmission while the WLAN traffic is accommodated. This time period allows a Bluetooth transmission to complete thereby avoiding a spurious noise transmission. In an alternative embodiment, Bluetooth transmission levels may be allowed to ramp up or down thereby avoiding spurious transmissions, which removes the need for the time period.

When WLAN traffic is being accommodated, the Bluetooth transmit attempted bus 231 may be asserted indicating that a Bluetooth transmission has been attempted. This action informs the WLAN processor 221 that simultaneous operation addressing both WLAN and Bluetooth traffic is required. For this condition, the WLAN processor 221 allows WLAN traffic to continue for another period of time before accommodating the indicated Bluetooth traffic. The traffic manager 220 then provides a time-sharing between both WLAN and Bluetooth traffic.

During any of the normal operating mode conditions discussed above, the Bluetooth transmit priority bus 232 may be asserted indicating that a priority Bluetooth transmission is required. This action causes the dual platform communication controller 200 to shift from a normal operating mode to a priority operating mode thereby interrupting any WLAN or normal Bluetooth traffic to accommodate the priority Bluetooth transmission. Upon completion of the priority Bluetooth transmission, the Bluetooth transmit priority bus 232 is de-asserted and the dual platform communication controller 200 returns its normal operating mode.

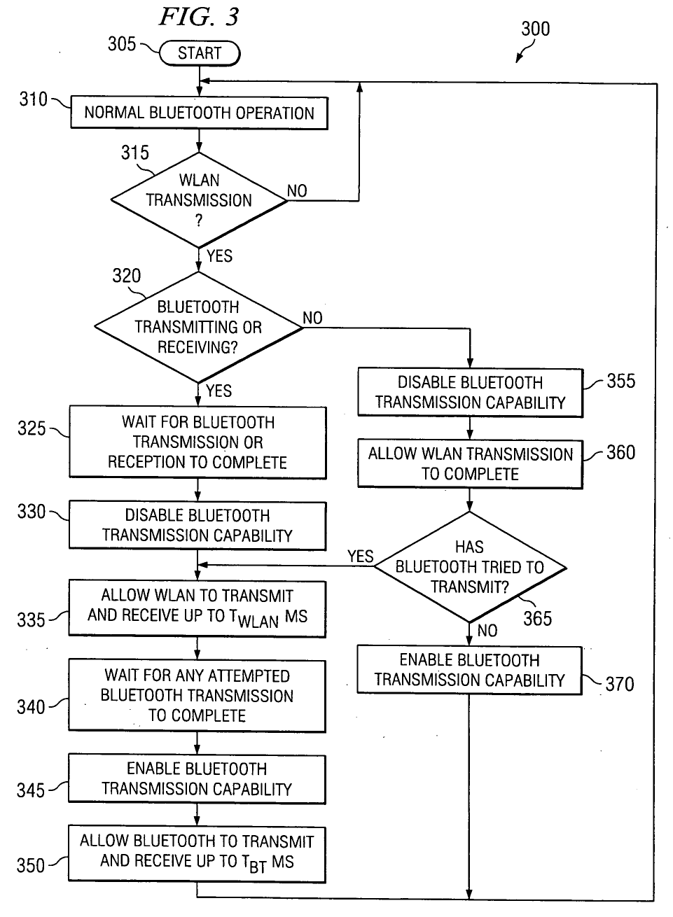

Turning now to FIG. 3, illustrated is a flow diagram of an embodiment of a method of controlling a dual platform communication, generally designated 300, carried out in accordance with the principles of the present invention. The method 300 recognizes a first signal packet based on a first communication standard and a second signal packet based on a second communication standard. Additionally, the method 300 provides a deterministic time-sharing between the first and second signal packets within a wireless communication system.

The method 300 represents an embodiment of a normal operating mode of the wireless communication system and starts in a step 305 with an intent to employ first and second communication standards. In the illustrated embodiment, the first communication standard conforms to an IEEE 802.11 standard defining a WLAN, and the second communication standard conforms to a Bluetooth standard. In a step 310, a default state is represented wherein a normal (non-priority) Bluetooth operation is allowed and there is no WLAN traffic.

In a first decisional step 315, it is determined whether there is a WLAN transmission request. If there is no WLAN request, the method 300 returns to the step 310 wherein normal Bluetooth operation continues. This sequence of steps represents a default operating condition. If a WLAN request is determined to exist in the first decisional step 320, a second decisional step 320 determines whether there is Bluetooth traffic.

If there is Bluetooth traffic, completion of the Bluetooth transmission or reception is monitored in a step 325. Upon completion of the Bluetooth transmission, Bluetooth transmission capability is disabled in a step 330, and WLAN transmission and reception is allowed for a period of time equal to TWLAN milliseconds in a step 335. Then in a step 340, any attempted Bluetooth transmission is monitored for completion, and Bluetooth transmission capability is enabled upon completion of the attempted Bluetooth transmission in a step 345. Bluetooth transmission and reception is allowed for a period of time equal to TBT milliseconds in a step 350. The method 300 then returns to the step 310 wherein the default state is resumed allowing normal Bluetooth operation.

If there is no Bluetooth traffic in the second decisional step 320, Bluetooth transmission capability is disabled in a step 355, and the WLAN transmission is allowed to complete in a step 360. Then in a third decisional step 365, it is determined whether there has been an attempted Bluetooth transmission. If there is no attempted Bluetooth transmission, Bluetooth transmission capability is again enabled in a step 370, and the method 300 returns to the step 310 wherein the default state is resumed allowing normal Bluetooth operation. If Bluetooth has attempted to transmit in the third decisional step 365, the method 300 returns to the step 335 allowing WLAN transmission and reception up to TWLAN milliseconds and progresses through the steps 340, 345, 350 before returning to the step 310.

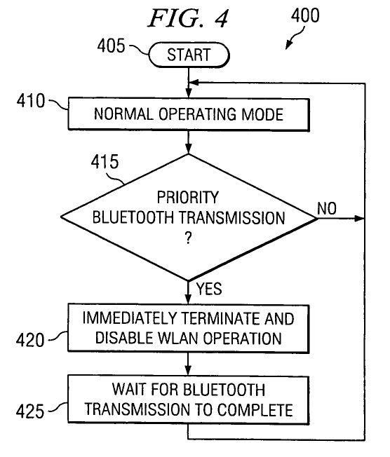

Turning now to FIG. 4, illustrated is a flow diagram of an embodiment of a method of controlling a dual platform communication, generally designated 400, carried out in accordance with the principles of the present invention. The method 400 represents an embodiment of a priority operating mode of the wireless communication system associated with the method 300 as discussed with respect to FIG. 3. The method 400 starts in a step 405 to provide for the need of accommodating a Bluetooth priority transmission, such as speech, which is transmitted in real-time and not re-transmitted.

A step 410 represents the collection of steps associated with the normal operating mode previously discussed in the method 300. In a decisional step 415, it is determined whether there is a priority Bluetooth transmission request. If there is no request, the method 400 returns to the step 410 and the normal operating mode continues as determined by the method 300. If there is a priority Bluetooth transmission request, WLAN operation (and normal Bluetooth operation) is immediately terminated and disabled in a step 420, and the priority Bluetooth transmission is monitored until its completion in a step 425. The method 400 returns to the step 410 wherein the normal operating mode of the method 300 continues.

While the methods disclosed herein have been described and shown with reference to particular steps performed in a particular order, it will be understood that these steps may be combined, subdivided, or reordered to form an equivalent method without departing from the teachings of the present invention. Accordingly, unless specifically indicated herein, the order and/or the grouping of the steps are not limitations of the present invention.

In summary, embodiments of the present invention employing a dual platform communication controller and a method of controlling a dual platform communication have been presented. Advantages of the controller and method include a deterministic and fair sharing of the wireless communication system when Bluetooth and WLAN both have traffic. Alternatively, the performance of either Bluetooth or WLAN is not substantially impacted when the other does not have traffic. Priority Bluetooth traffic, such as speech, is given precedence over all WLAN and normal Bluetooth traffic, and a Bluetooth transmission is not interrupted thereby avoiding resulting spurious transmissions that may cause regulatory or certification problems.

Although the present invention has been described in detail, those skilled in the art should understand that they can make various changes, substitutions and alterations herein without departing from the spirit and scope of the invention in its broadest form.

What is claimed is:

1. A dual platform communication controller for use with a wireless communication system, comprising:
a signal interpreter coupled to said wireless communication system and configured to recognize a first signal packet based on a first communication standard and a second signal packet based on a second communication standard; and
a traffic manager coupled to said signal interpreter and configured to provide a deterministic time-sharing between said first and second signal packets within said wireless communication system.

2. The controller as recited in claim 1 wherein said first communication standard is configured to be IEEE 802.11.

3. The controller as recited in claim 1 wherein said second communication standard is configured to be Bluetooth.

4. The controller as recited in claim 1 wherein said traffic manager is configured to provide said deterministic time-sharing between said first and second signal packets based on a real-time requirement.

5. The controller as recited in claim 1 wherein said traffic manager is configured to provide said deterministic time-sharing between said first and second signal packets based on a period of time.

6. The controller as recited in claim 1 wherein said traffic manager is configured to provide said deterministic time-sharing between said first and second signal packets by inhibiting a transmission capability of at least one of said first and second signal packets.

7. The controller as recited in claim 1 wherein said traffic manager is further configured to operate in a default state having a listening mode and a standby mode.

8. A method of controlling a dual platform communication for use with a wireless communication system, comprising:
recognizing a first signal packet based on a first communication standard and a second signal packet based on a second communication standard; and
providing a deterministic time-sharing between said first and second signal packets within said wireless communication system.

9. The method as recited in claim 8 wherein said first communication standard is IEEE 802.11.

10. The method as recited in claim 8 wherein said second communication standard is Bluetooth.

11. The method as recited in claim 8 wherein said providing a deterministic time-sharing between said first and second signal packets is based on a real-time requirement.

12. The method as recited in claim 8 wherein said providing said deterministic time-sharing between said first and second signal packets is based on a period of time.

13. The method as recited in claim 8 wherein said providing said deterministic time-sharing between said first and second signal packets employs inhibiting a transmission capability of at least one of said first and second signal packets.

14. The method as recited in claim 8 wherein said providing further provides operating in a default state having a listening mode and a standby mode.

15. A wireless communication system, comprising:
a first wireless network based on a first communication standard that employs a first wireless station and a first signal packet;
a second wireless network based on a second communication standard that employs a second wireless station and a second signal packet; and
a dual platform communication controller coupled to said first and second wireless networks, including:
a signal interpreter that recognizes said first signal packet based on said first communication standard and said second signal packet based on said second communication standard, and
a traffic manager, coupled to said signal interpreter, that provides a deterministic time-sharing between said first and second signal packets within said wireless communication system.

16. The system as recited in claim 15 wherein said first communication standard is IEEE 802.11.

17. The system as recited in claim 15 wherein said second communication standard is Bluetooth.

18. The system as recited in claim 15 wherein said traffic manager provides said deterministic time-sharing between said first and second signal packets based on a real-time requirement.

19. The system as recited in claim 15 wherein said traffic manager provides said deterministic time-sharing between said first and second signal packets based on a period of time.

20. The system as recited in claim 15 wherein said traffic manager provides said deterministic time-sharing between said first and second signal packets by inhibiting a transmission capability of at least one of said first and second signal packets.

21. The system as recited in claim 15 wherein said traffic manager further operates in a default state having a listening mode and a standby mode.
